(19) United States
(12) Patent Application Publication
(10) Pub. No.: US 2026/0153283 A1
(43) Pub. Date: Jun. 4, 2026

(54) REFRIGERATOR

(71) Applicant: LG ELECTRONICS INC., Seoul (KR)

(72) Inventors: Chungseob Lee, Seoul (KR); Wonho Park, Seoul (KR); Namgyo Lee, Seoul (KR)

(73) Assignee: LG ELECTRONICS INC., Seoul (KR)

(21) Appl. No.: 19/403,613

(22) Filed: Nov. 28, 2025

(30) Foreign Application Priority Data
Nov. 29, 2024 (KR) 10-2024-0174405

(51) Int. Cl. F25D 23/02; E05F 1/10; E05F 1/16; F25D 11/02

(52) U.S. Cl. CPC F25D 23/028; E05F 1/10; E05F 1/16; F25D 11/02; E05Y 2201/426; E05Y 2201/604; E05Y 2900/31

(57) ABSTRACT

A refrigerator of the present disclosure includes: a cabinet defining a storage space that is opened forward; a door disposed at a front of the cabinet and configured to open and close the storage space; and an opening module provided inside the door. The opening module includes: a handle including a handle rotating shaft defining a center of rotation in a left-right direction, an operation part exposed to an outside of the door and located above the center of rotation, and a lever located below the center of rotation; a link including a link rotating shaft disposed in an up-down direction, a first arm extending from the link rotating shaft toward the handle and contacting the lever, and a second arm extending from the link rotating shaft toward an opposite side of the handle; and a pusher that is slidable backward so as to protrude from a rear surface of the door by the second arm.

### BACKGROUND OF THE INVENTION

### 1. Field of the invention

The following disclosure relates to a refrigerator.

### 2. Description of the Related Art

A refrigerator has a storage space that is shielded by a door, and food can be stored in the storage space at a low temperature. The refrigerator may cool the inside of the storage space using cool air generated through heat exchange with a refrigerant circulating in a refrigeration cycle. Recently, refrigerators are becoming larger and multi-functional with changes of dietary habits and premiumization of products, and refrigerators having various structures and convenience devices for convenience of users and for efficient use of internal spaces are being released.

The storage space of the refrigerator may be opened/closed by the door. Further, the refrigerator may be classified into various types according to the arrangement of storage spaces and the structure of doors that open and close the storage spaces. For example, the doors of the refrigerator may be opened and closed by rotation or inserted or withdrawn by sliding.

A user may open and close the door. The door is difficult to handle if it is large and heavy, or if a pressure difference between the inside and outside the refrigerator is large, and/or if a magnetic force of a door gasket is large. For example, a greater force may be required to open the door, causing inconvenience to the user.

Korean Patent No. 10-1528729 (hereinafter referred to as Patent No. 729) discloses a refrigerator with a door opening device for initially opening a door by pushing a main body. The door opening device disclosed in Patent No. 729 includes a grip part operated by a user, a pivoting member having a pivoting shaft and an operating portion, and a push unit that slides by the operating portion so as to push the main body.

In the door opening device disclosed in Patent No. 729, the pivoting member and the push unit are in direct contact with each other during operation of the door opening device, such that at least a portion of the push unit is required to be disposed at the same position as the pivoting member, and thus, the arrangement of the pivoting member and the push unit is significantly limited.

In recent living environments, a cabinet to accommodate a refrigerator is provided or a refrigerator is placed next to other furniture. The existing refrigerator with a thick door has a problem in that its thickness in the front-rear direction is larger than the thickness of a refrigerator cabinet or other furniture, such that the refrigerator protrudes more forwardly than other furniture, causing inconvenience to users, and adversely affecting the interior design.

In consideration of the above problem, there is a growing demand for a refrigerator including a door with reduced thickness. However, the existing door opening devices are difficult to be mounted to a thin door.

### SUMMARY OF THE INVENTION

It is an objective of the present disclosure to solve the above and other problems.

It is another objective of the present disclosure to provide a refrigerator including an opening module that opens a door.

It is yet another objective of the present disclosure to provide a refrigerator including an opening module having a small volume.

It is yet another objective of the present disclosure to provide a refrigerator that requires less force to initially open a door.

It is yet another objective of the present disclosure to provide a refrigerator including an opening module in which positions of a handle operated by a user and a pusher that pushes a door forward are separated.

It is yet another objective of the present disclosure to provide a refrigerator in which when a user opens a door, the user's actions for initial opening and subsequent opening are separated.

It is yet another objective of the present disclosure to provide a refrigerator in which a user may initially open a door by pushing a handle in a rearward direction opposite to a direction in which the user opens the door.

It is yet another objective of the present disclosure to provide a refrigerator allowing a user to initially open a door by moving a door handle upward.

It is yet another objective of the present disclosure to provide a refrigerator in which when filling the interior of a door with an insulation material, the insulation material may be smoothly filled in a gap between a case of an opening module that initially opens the door and a front panel of the door.

It is yet another objective of the present disclosure to provide a refrigerator including a door having high insulation efficiency.

It is yet another objective of the present disclosure to provide a refrigerator capable of preventing condensation on a door.

It is yet another objective of the present disclosure to provide a refrigerator including a door with improved mechanical operation stability.

It is yet another objective of the present disclosure to provide a refrigerator with improved door opening reliability.

The objectives of the present disclosure are not limited to the aforementioned objectives and other objectives not described herein will be clearly understood by those skilled in the art from the following description.

In accordance with an aspect of the present disclosure, the above and other objectives can be accomplished by providing a refrigerator including a cabinet defining a storage space, a door opening and closing the storage space, and an opening module.

The storage space may be open toward the front.

The door may be disposed at a front of the cabinet.

The opening module may be disposed inside the door.

The opening module may include: a handle, a link, and a pusher.

The handle may include a handle rotating shaft defining a center of rotation in a left-right direction.

The handle may include an operation part exposed to an outside of the door and located above the center of rotation, and a lever located below the center of rotation.

The link may include a link rotating shaft disposed in an up-down direction.

The link may include a first arm extending from the link rotating shaft toward the handle, and a second arm extending from the link rotating shaft toward an opposite side of the handle.

The first arm may contact the lever. The first arm may be disposed at a front of the lever.

The pusher may be configured to be pushed by the second arm to slide rearward and protrude from a rear surface of the door. The pusher may be disposed behind the second arm.

When the handle rotates in a first rotation direction, the pusher may move backward. The first rotation direction may be a rotation direction of the handle in which the operation part moves backward.

The cabinet may include a side wall disposed outside the storage space in a width direction and extending vertically.

The pusher may be disposed in front of the side wall.

When the handle rotates in the first rotation direction so that the operation part moves backward, the pusher may move backward relative to the door while being in contact with the side wall of the cabinet.

A width of the pusher in the left-right direction may be smaller than a height thereof in the up-down direction.

The opening module may further include a supporter disposed outside the handle in a width direction of the door and configured to accommodate the rotating shaft of the handle.

A center of rotation of the handle may be located in front of the rotating shaft of the link.

The door may include a front panel facing forward and having an opening.

The operation part may include: a front surface facing forward and exposed to an outside through the opening of the door; and a grip disposed behind the front surface and recessed upward.

When the door closes the storage space, a lower end of the front surface of the operation part may be disposed in front of the center of rotation of the handle.

When the handle rotates in the first rotation direction so that the lower end of the front surface moves upward along a rotation trajectory, the pusher may move backward relative to the door.

The handle may further include: a body defining the handle rotating shaft and extending in the left-right direction; and a neck extending between the body and the operation part.

The lever may include a first side end and a second side end protruding downward from a left side end and a right side end of the body.

The link may include: a first link contacting the first side end; and a second link contacting the second side end.

The pusher may include: a first pusher contacting the first link; and a second pusher contacting the second link.

The door may further include a door liner facing the storage space and disposed behind the front panel.

The opening module may further include a case disposed between the front panel and the door liner of the door, and configured to accommodate the body, the lever, the link, and the pusher.

An insulation material may be filled in a gap between the front panel and the door liner of the door, and the insulation material may be filled in a gap between at least a portion of the case and the front panel in a front-rear direction.

The opening module may further include an elastic member pressing the pusher forward.

The door may include: a door part closing the storage space; and a basket disposed behind the door part and disposed in the storage space. The door may be withdrawn forward from the storage space to open the storage space, and may be slid backward to close the storage space.

The refrigerator may further include a hinge fixed to the cabinet, wherein the door may be rotatably coupled to the hinge to open and close the storage space, and the opening module may be disposed on an opposite side of the hinge in the width direction of the door.

In accordance with another aspect of the present disclosure, the above and other objectives can be accomplished by providing a refrigerator including: a cabinet defining a storage space open forward; a door disposed at a front of the cabinet and configured to open and close the storage space; and an opening module disposed inside the door, wherein the opening module includes: a handle including a handle rotating shaft defining a center of rotation in a left-right direction, an operation part exposed to an outside of the door and located above the center of rotation, and a lever located below the center of rotation; a link including a link rotating shaft disposed in an up-down direction, a first arm extending from the link rotating shaft toward the handle and disposed in front of the lever, and a second arm extending from the link rotating shaft toward an opposite side of the handle; and a pusher disposed behind the second arm, and configured to move backward and protrude from a rear surface of the door when the handle rotates in a first rotation direction so that the operation part moves backward.

Other detailed matters of the exemplary embodiments are included in the detailed description and the drawings.

### EFFECTS OF THE INVENTION

According to at least one of the embodiments of the present disclosure, a refrigerator including an opening module that opens a door may be provided.

According to at least one of the embodiments of the present disclosure, a refrigerator including an opening module having a small volume may be provided.

According to at least one of the embodiments of the present disclosure, a refrigerator that requires less force to initially open a door may be provided.

According to at least one of the embodiments of the present disclosure, a refrigerator including an opening module, in which positions of a handle operated by a user and a pusher that pushes a door forward are separated, may be provided.

According to at least one of the embodiments of the present disclosure, a refrigerator, in which when a user opens a door, the user's actions for initial opening and subsequent opening are separated, may be provided.

According to at least one of the embodiments of the present disclosure, a refrigerator, in which a user may initially open a door by pushing a handle in a rearward direction opposite to a direction in which the user opens the door, may be provided.

According to at least one of the embodiments of the present disclosure, a refrigerator allowing a user to initially open a door by moving a door handle upward may be provided.

According to at least one of the embodiments of the present disclosure, a refrigerator in which when filling the interior of a door with an insulation material, the insulation material may be smoothly filled in a gap between a case of an opening module that initially opens the door and a front panel of the door, may be provided.

According to at least one of the embodiments of the present disclosure, a refrigerator including a door having high insulation efficiency may be provided.

According to at least one of the embodiments of the present disclosure, a refrigerator capable of preventing condensation on a door may be provided.

According to at least one of the embodiments of the present disclosure, a refrigerator including a door with improved mechanical operation stability may be provided.

According to at least one of the embodiments of the present disclosure, a refrigerator with improved door opening reliability may be provided.

### BRIEF DESCRIPTION OF THE DRAWINGS

FIG. 1 is a perspective view of a refrigerator according to an embodiment of the present disclosure;

FIG. 2 is an exploded perspective view of a door of a refrigerator according to a first embodiment of the present disclosure;

FIG. 3 is an exploded perspective view of an opening module illustrated in FIG. 2;

FIG. 4 is a diagram illustrating an opening module and a cap illustrated in FIG. 2 that are mounted to a door;

FIGS. 5 to 7 are diagrams illustrating a handle, a link, and a pusher of the opening module illustrated in FIG. 3;

FIG. 8 is a diagram explaining an assembly process of an opening module illustrated in FIG. 2;

FIG. 9 is a diagram illustrating the handle and the link illustrated in FIG. 5;

FIG. 10 is a diagram illustrating the pusher illustrated in FIG. 5;

FIG. 11 is a front view of a door of a refrigerator according to a second embodiment of the present disclosure;

FIG. 12 a rear perspective view of the door of the refrigerator according to the second embodiment of the present disclosure;

FIG. 13 is an exploded perspective view of the door illustrated in FIG. 11;

FIG. 14 is (a) a perspective view and (b) a conceptual top view illustrating a handle, a link, and a pusher illustrated in FIG. 13;

FIGS. 15 and 16 are conceptual diagrams illustrating an operation of a door and an opening module illustrated in FIG. 11;

FIG. 17 is a conceptual diagram illustrating a door and an opening module of a refrigerator according to a third embodiment of the present disclosure;

FIG. 18 is a conceptual diagram illustrating a door and an opening module of a refrigerator according to a fourth embodiment of the present disclosure; and

FIG. 19 is a perspective view of a refrigerator according to a fifth embodiment of the present disclosure.

### DETAILED DESCRIPTION OF THE PREFERRED EMBODIMENTS

Hereinafter, the present disclosure will be described in detail with reference to the accompanying drawings, in which the same reference numerals are used throughout the drawings to designate the same or similar components, and a redundant description thereof will be omitted.

The suffixes, such as “module” and “unit,” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly indicates otherwise.

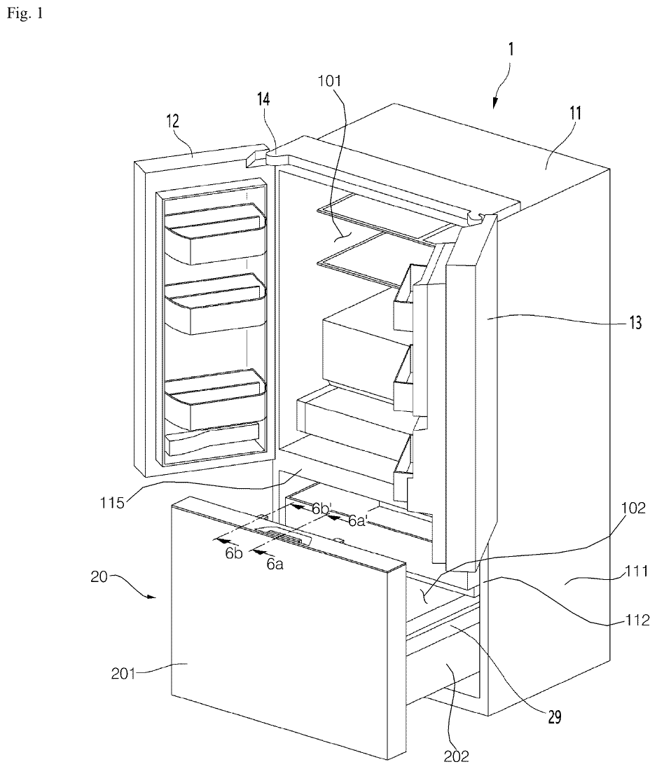

Referring to FIG. 1, a refrigerator 1 includes a cabinet 11 defining storage spaces 101 and 102. The storage spaces 101 and 102 may be provided in the cabinet 11. The refrigerator 1 includes doors 12, 13, and 20 that open and close the storage spaces 101 and 102. Hereinafter, the storage spaces 101 and 102 may be referred to as storage chambers 101 and 102. Hereinafter, the interior of the storage chambers 101 and 102 may be referred to as the interior of the refrigerator.

A plurality of storage chambers 101 and 102 may be provided, one of which is provided as a refrigerating compartment, and the other one is provided as a freezing compartment. For example, a first storage chamber 101 may be provided at an upper side and a second storage chamber 102 may be provided at a lower side. For example, the first storage chamber 101 may be provided as a refrigerating compartment, and the second storage chamber 102 may be provided as a freezing compartment.

The following description will be made using a bottom freezer type refrigerator having the freezing compartment provided at a lower side thereof as an example, but the present disclosure may also be applied to other types of refrigerators.

The refrigerator 1 may include a partition plate 115 that partitions the first storage chamber 101 and the second storage chamber 102. The partition plate 115 may vertically partitions the first and second storage chambers 101 and 102.

The above configuration of storage chambers is exemplary, and the present disclosure is not limited thereto. For example, the second storage chamber 102 may be provided as a refrigerating compartment. Alternatively, the first and second storage chambers may be provided side-by-side.

The doors 12, 13, and 20 may include a first door 12 and 13 for opening and closing the first storage chamber 101, and a second door 20 for opening and closing the second storage chamber 102.

The first door may rotate about a hinge 14 as a support axis. The first door 12 and 13 may include a left door 12 and a right door 13.

The second door 20 may be slidably mounted to the cabinet 11. The second storage chamber 102 may be opened and closed by insertion and withdrawal of the second door 20. The second door 20 may include a door part 201 that opens and closes the second storage chamber 102, and a basket 202 disposed on a rear surface of the door part 201. A rail 29 may be disposed behind the second door. The rail may guide insertion and withdrawal of the second door.

The second door 20 may be referred to as a drawer type door 20. The refrigerator may include different types of opening/closing doors. The refrigerator may include a combination of various types of opening/closing doors. An opening module and the like of the present disclosure may be applied to different types of doors.

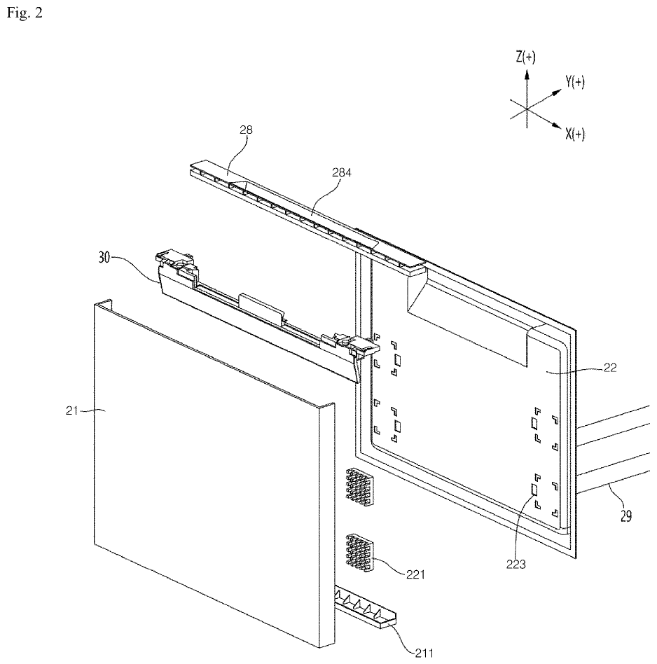

The first door 12 and 13 may be provided with an opening module 30 (see FIG. 2). The second door 22 may be provided with the opening module 30. An external force may be applied to the opening module 30. A user may operate the door by using the opening module 30. By operating the opening module 30, the doors 12, 13, and 20 may be withdrawn from the storage chambers 101 and 102. For example, the opening module 3 may open the door by overcoming the weight of the door, pressure difference between the interior and exterior of the refrigerator, and/or attraction force of a gasket. In this case, the opening of the door may refer to initial opening. The gasket 113 may include a magnetic substance, and the attraction force may refer to a magnetic force. Alternatively, the gasket 113 may seal a gap between the door 20 and the cabinet 11, and the attraction force may be an attraction force generated due to a pressure difference between the interior and exterior of the storage space of the cabinet 11 when the door 20 opens.

The opening of the door will be described below. The opening of the door may include initial opening and non-initial opening. The initial opening may refer to an initial opening state of the door in which the door 20 starts to open. The non-initial opening may refer to an opening state of the door after the initial opening is terminated. The weight of the door may act as a resistance force against the initial opening and the non-initial opening. The resistance force may refer to a force to resist opening of the door so that the door does not open. The pressure difference between the interior and exterior of the refrigerator may greatly act at the beginning of the initial opening. The resistance force due to the pressure difference between the interior and exterior of the refrigerator during the initial opening of the door may rapidly disappear. The magnetic force of the gasket may be applied to the entire door during the initial opening of the door. The magnetic force of the gasket may gradually decrease over the entire period of the initial opening.

The opening module 30 may provide force for overcoming the resistance force against the initial opening. For example, when the opening module 30 operates, initial opening of the door and the cabinet may be achieved. For example, a user may operate the opening module 30 with a finger to initially open the door. Then, the door may be operated by the user's arm. The user may perform actions, such as touching, holding, pushing, pulling, and/or pressing the opening module 30. An automatic mechanism, which is used instead of the user or is added, may operate the opening module 30. The opening module 30 may be provided at the edge of the first and second doors 12, 13, and 20.

The opening module 30 may be provided at an upper end of the second door 20.

The following description will be made of an example in which the opening module 30 is provided for the second door 20. In the following description, the second door may be preferentially considered. Obviously, the door may be the first door.

Referring to FIG. 2, a left-right direction of the door may be defined as the X-axis direction, and a front-rear direction of the door may be defined as the Y-axis direction. An up-down direction of the door may be defined as the Z-axis direction.

The door 20 may include an outer panel 21 facing the outside of the cabinet 11 and an inner panel 22 facing the storage chamber 102. The outer panel 21 faces forward, and the inner panel 22 faces rearward. The outer panel 21 may be made of a metal material. The inner panel 22 may be made of a resin material. The outer panel 21 may be referred to as a front panel 21. The inner panel 22 may be referred to as a door liner 22.

Both side surfaces of the door 20 may be protected by a portion that extends from one of the panels. For example, the outer panel 21 may include side surfaces at both ends of the external panel 21.

The door 20 may include a bottom 211 that protects a lower portion.

The door 20 may include a cap 28 that defines an upper surface. The cap 28 may have a cap recess 284. The cap recess 284 may define a space for receiving a user's hand. The cap recess 284 may have a convex structure into which the user's hand is put. The cap recess 284 may accommodate at least a portion of the opening module 30. The cap recess 284 may be recessed toward the lower side of the cap 28. The cap recess 284 may include a portion which is recessed toward the lower side of the door 20.

The door 20 may include a rail 29 extending rearward from the inner panel 22. The rail 29 may be fastened to the inner panel 22 by a fastening member. A rail mount 221 may be fastened to the inner panel 22. The inner panel 22 may have a rail recess 223. The rail mount 221 may be aligned with the rail recess 223. The rail mount 221 and the rail 29 may be fastened to each other by the fastening member. The rail 29 and the inner panel 22 may be securely fastened to each other by the rail mount 221. The rail 29 may be firmly fixed to the inner panel by the rail mount 221 even though the thickness (length in the Y-axis direction) of the door is small.

The opening module 30 may include a pusher 6. The pusher 6 may be mounted at an upper end or left and right ends of the door.

The pusher 6 may vertically overlap at least a portion of the rail mount 221. The pusher 6 and the rail mount 221 may be adjacent to each other in the left-right direction without vertically overlapping each other.

The rail mount 221 and the rail 29 may overlap each other in the front-rear direction. A pushing action of the pusher 6 may be directly applied to the rail. Here, the direct application may refer to no or small moment in the left-right direction (X). The pushing action of the pusher 6 may be directly applied to the load. Here, the load may refer to a rail that supports the door and items to be accommodated. Accordingly, the door 20 may open smoothly. This action may result from the direction of rotation of a second shaft 71 that is parallel to the Z-axis, and/or the link 7 that moves toward the left and right ends of the door. The link 7 and the second shaft 71 will be described in detail later.

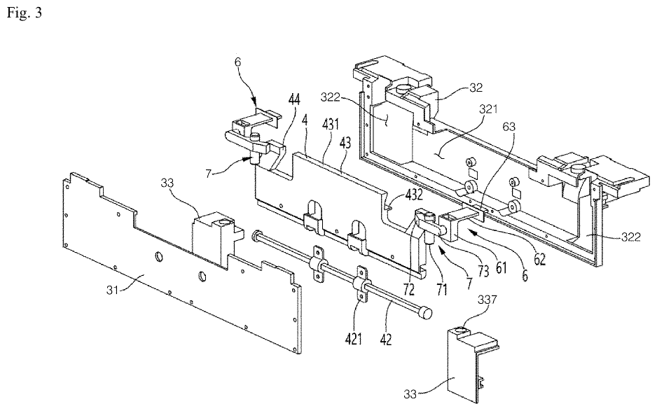

Referring to FIG. 3, the door 20 may include the opening module 30. The opening module 30 may include a handle 4. The opening module 30 may include a case 31 and 32 that accommodates the handle 4. A case cover 31 may be coupled to the case 32. The handle may be accommodated in a space formed by coupling the case 32 and the case cover 31. In addition, the link 7 and the pusher 8 which will be described below may be disposed in the space. The case 32 described herein may be a concept including the case 32 and the case cover 31.

The opening module 30 may include a grip contacted by a user. The grip may also be referred to as a contact member. The grip may be a portion of the handle 4 or may be a part fastened to the handle 4.

The handle 4 may have a portion extending in the up-down direction (Z). The handle 4 may include a portion formed at a central portion of the handle 4 and extending in the up-down direction. The central portion of the handle may be referred to as a first region. The handle 4 may include a second region at the side of the first region 40. The first region may have a greater height than the second region in the vertical direction.

The handle 4 may include a first pressing part 43. The first pressing part 43 may be disposed at an upper portion of the first region. The first pressing part 43 may include a vertical portion extending vertically. The vertical portion 431 may be a portion that is directly touched by a user's finger.

The handle 4 may include a horizontal portion 432 that is disposed at an approximately intermediate portion or a lower portion of the vertical portion 431. The installation positions of the vertical portion 431 and the horizontal portion 432 may vary depending on the depth or shape of the cap recess 284. The horizontal portion 432 may extend rearward (+Y) from a rear surface of the vertical portion 431. The horizontal portion 432 may have a predetermined length in the left-right direction. The horizontal portion 432 may extend along an upper surface of a lower wall of the cap recess 284. The horizontal portion 432 may prevent foreign materials from entering the opening module 30. At least a portion of the horizontal portion 432 may contact the wall of the cap recess 284. The horizontal portion may slide along the wall of the cap recess 284.

The handle 4 may include a second pressing part 44. The second pressing part 44 may be disposed at an upper portion of the second region. When the first pressing part 43 is pushed, the handle 4 may rotate about a first shaft 42. The handle 4 may rotate in the first direction as a central axis. The first shaft 42 may be fastened to a lower portion of the handle 4. The first shaft 42 may be fastened to the case 32 by a first shaft mount 421. The first shaft mount 421 and the case 32 may be fastened to each other by a fastening tool. Here, the fastening tool may be a screw. The handle 4 may be fixed to the case 22 by the first shaft mount 421. Both ends of the first shaft 42 may be supported by a supporter 33. The supporter 33 may support the handle 4 at both sides of the first shaft 42.

The opening module 30 may include a link 7 that is rotated by the handle 4. When the handle 4 rotates, the second pressing part 44 may push the link 7. The link 7 may rotate about a second shaft 71. The link 7 may be supported by the supporter 33. The link 7 may be supported by the case 32. The second shaft 71 may extend in the up-down direction (Z). The second shaft 71 may extend in a direction intersecting the first shaft 42. The link 7 may extend in the left-right direction (X). The link 7 may include a third pressing part 72 provided at an inner portion of the link 7. The link 7 may include a fourth pressing part 73 provided at an outer portion of the link 7.

The opening module 30 may include a pusher 6. The pusher 6 may push the cabinet 11.

As the fourth pressing part 73 is provided at the outer portion of the link 7, the pusher 6 may be located further outward. Here, the inside and the outside of the link 7 may be determined based on the center of the opening module 30. If there is no explanation for a reference position for the inside and the outside, the center of the opening module 30 may be used as the reference position. The third pressing part 72 and the fourth pressing part 73 may be adjacent to an extended end portion of the link 7. The fourth pressing part 73 may push the pusher 6.

The pusher 6 may protrude between the door 20 and the cabinet 11. The pusher 6 may have an outer end 61 extending in the up-down direction (Z). The pusher 6 may include an extension portion 62 extending in the front-rear direction (Y). A rear end of the extension portion 62 may have an inner end 63. The supporter 33 may guide the pusher 6.

The second pressing part 44 and the third pressing part 72 may be positioned inward relative to the second shaft 71. The fourth pressing part 73 may be positioned outward relative to the second shaft 71. The first shaft 42 and the second shaft 71 may extend in a direction intersecting each other. The first shaft 42 and the second shaft 71 may extend in a direction orthogonal to each other. Accordingly, the pusher 6 may be positioned further outward.

Accordingly, the pusher 6 and the rail mount may vertically overlap or abut each other, such that the door may have a thin front wall, resulting in a long length of insulation. Accordingly, the insulation effect may be improved, and the internal volume of the refrigerator may increase, thereby allowing a user to open the door conveniently with less force.

The case 31 and 32 may include a support plate. The case 31 and 32 may include the case cover 31 and the case body 32. The case body 32 may define a recess 321 recessed rearward (+Y). The recess 321 may accommodate at least a portion of the handle 4. An opening part 322 may be disposed at both left and right ends of the recess 321. The opening part 322 may be closed by the supporter 33. A rear surface of the case cover 31 may be fastened to a front surface of the case body 32. The opening module 30 may be shielded from the outside by the case 32, the case cover 31, and the supporter 33, thereby preventing a foam member or an insulation member from entering.

The supporter 33 may include a bearing 334 and 337. The bearing 334 and 337 may support at least one of the first shaft 42 and/or the second shaft 71. The bearing 334 and 337 may include a first bearing 334 having a portion that extends in the left-right direction. The first bearing 334 may support the first shaft 42. The bearing 334 and 337 may include a second bearing 337 having a portion that extends in the up-down direction. The second bearing 337 may support the second shaft 71.

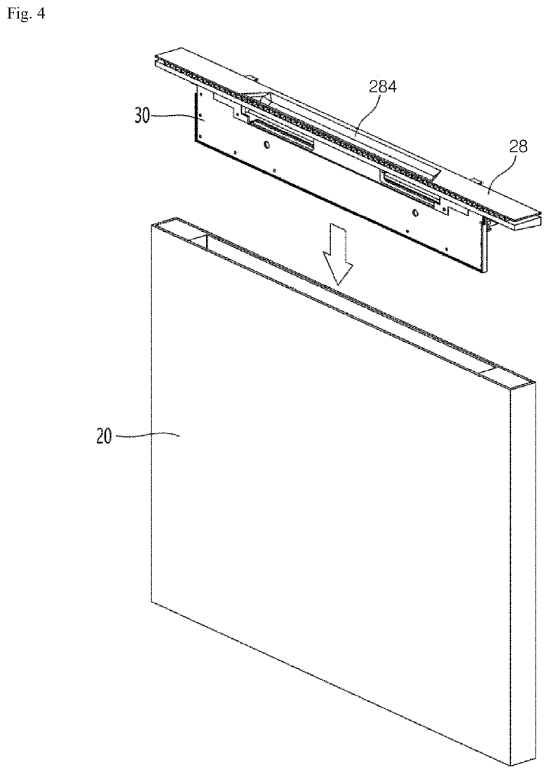

Referring to FIG. 4, the cap recess 284 may be elongated in the left-right direction, thereby improving user accessibility. A user may access not only the center of the door but also any part of the cap recess 284 that is elongated in the width direction of the door 20.

The opening module 30 and the cap 28 are fastened to define a first assembly. The outer panel 21, the inner panel 22, and the bottom 211 are fastened to define a second assembly. The first assembly may be fastened to the upper surface of the second assembly. In the above configuration, an insulation space may be provided inside the door. The interior of the door may be insulated with a foam member and/or an insulation material.

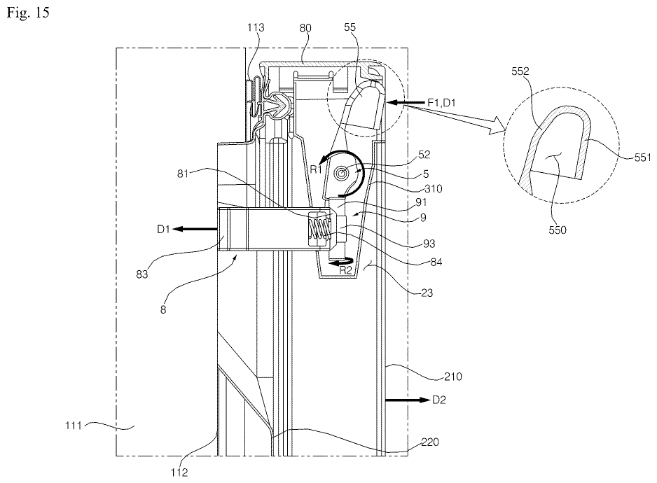

A space 23 (see FIG. 15) between the case 31 and 32 of the opening module 30 and the door panel 21 and 22 may be filled with a foam member and/or an insulation material. The interior of the door may be filled with the foam member. The interior space, defined by the rear side of the outer panel, the front side of the inner panel, the upper side of the bottom, the lower side of the cap, and the left side and the right side on which the inside of the door is viewed from the wing, may be filled with the foam member. The exterior space of the opening module 30 may be filled with the foam member. The interior space of the opening module 30 may not be filled with the foam member. A space between the opening module 30 and the outer panel, a space between the opening module 30 and the inner panel, a space between the opening module 30 and the bottom, and a space between the opening module 30 and the cap, and/or a space between the opening module 30 and the wing may be filled with the foam member. The foam member may be made of a resin material, polystyrene (PS), and/or a porous material. A vacuum insulation member may be used instead of or in combination with the foam member.

The cap 28 may be fastened to at least one of the inner panel and/or the outer panel. The cap may be fastened to at least one of the inner panel and/or the outer panel when the opening module 30 is fastened. The cap may be fastened to an upper end of at least one of the inner panel and/or the outer panel. The cap may be fastened to at least one of the inner panel and/or the outer panel via a protrusion and groove arrangement. The inner panel and the outer panel may have upper ends having the same height. The inner panel and the outer panel may not define a recessed portion and/or a protruding portion in the front-rear direction (Y) for fastening the cap. The inner panel and the outer panel may not define a recessed portion and/or a protruding portion in the up-down direction (Z) for fastening the cap. At least one of a gap between the cap and the inner panel and/or a gap between the cap and the outer panel may be filled with a foam member. The cap and the opening module 30 may be firmly seated in the door by the foam member.

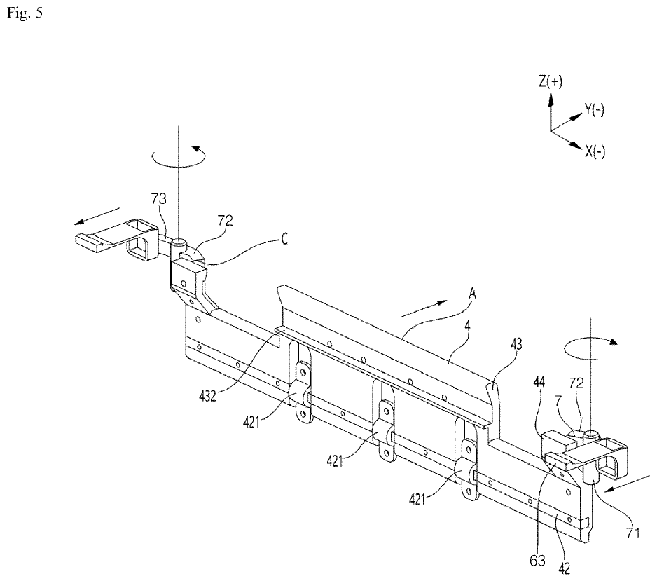

Referring to FIG. 5, the opening module 30 may initially open the door. The contact member may be moved forward (−Y) by an external force. The handle 4 may be rotated by the external force. The handle 4 may rotate about the first shaft 42 in a first direction. The first shaft 42 may extend in the left-right direction (X). The first direction may be a direction of rotation with respect to the left-right direction (X). The handle 4 may rotate the link 7. The link 7 may rotate about the second shaft 71 in a second direction. The second shaft 71 may extend in the up-down direction (Z). The second direction may be a direction of rotation with respect to the up-down direction (Z). The first direction and the second direction may be directions that intersect each other. The first direction and the second direction may be directions that are orthogonal to each other. The link 7 may push the pusher 6 rearward (+Y). The pusher 6 and the cabinet may perform an action/reaction motion. When the pusher 6 pushes the cabinet, the door may be initially opened.

The handle 4 may rotate as the grip moves forward (−Y). The handle 4 may rotate about the first shaft 42 in the first direction. The handle 4 may rotate the link 7. The link 7 may rotate about the second shaft 71 in the second direction. The first and second directions may be opposite directions. The link 7 may push the pusher 6 rearward (+Y). The pusher 6 and the cabinet may perform an action/reaction motion. When the pusher 6 pushes the cabinet 11, the door 20 may be initially opened. The cabinet 11 may include a stationary member, unlike door operations.

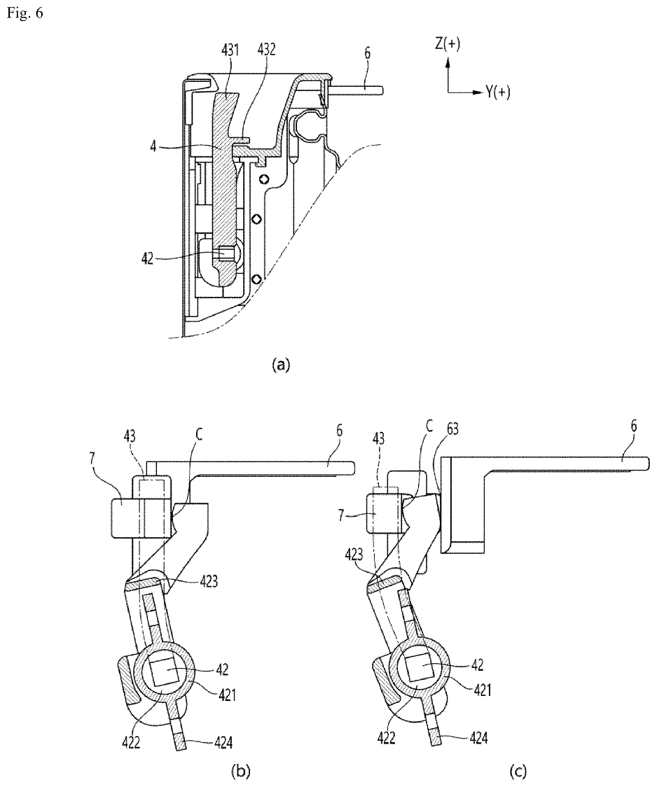

Referring to FIG. 6, the handle 4 may rotate counterclockwise by an external force. The handle 4 may rotate about the first shaft 42 that extends in the left-right direction. During rotation of the handle 4, the second pressing part 44 and the third pressing part 72 may contact with each other. The link 7 may rotate about the second shaft 71. The fourth pressing part may push the pusher 6 rearward (+Y).

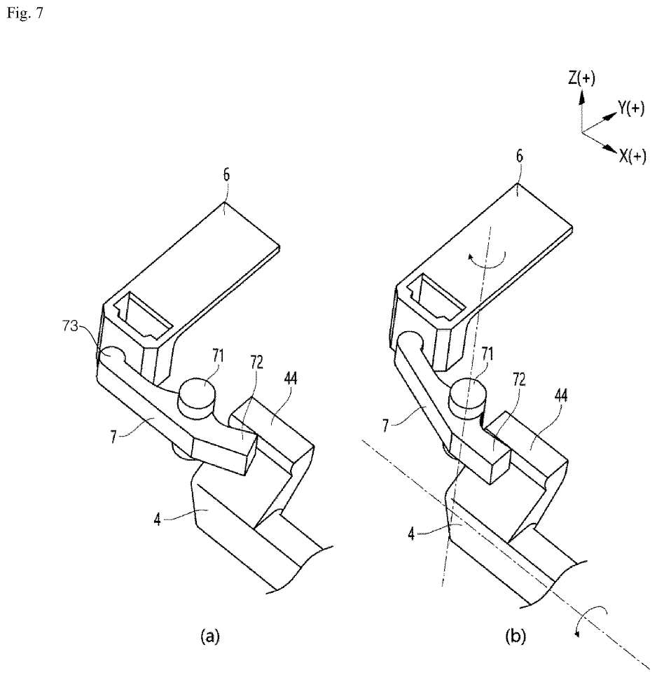

Referring to FIGS. 6 and 7, the handle 4 may rotate counterclockwise about the first shaft 42 (see FIG. 6). The second pressing part 44 of the handle 4 may push the third pressing part 72 of the link 7 forward (−Y). The link 7 may rotate clockwise about the second shaft 71 (see FIG. 7). The link 7 may extend in the left-right direction (X). The third pressing part 72 and the fourth pressing part 73 may be spaced apart from each other in the left-right direction (X). The fourth pressing part 73 may be biased toward the outside of the opening module 30. The fourth pressing part 73 of the link 7 may push the pusher 6 rearward (+Y). The pusher 6 may push the cabinet. The door 20 may be initially opened by the pusher 6.

The opening module 30 may include a bearing 422 that supports the first shaft 42. The bearing 422 may be disposed outside the first shaft 42. The first shaft mount 421 may support the bearing 422. The bearing 422 may freely rotate between the first shaft 42 and the first shaft mount 421. The bearing 422 may move to slide between two members. The bearing 422 may move to slide with respect to any one adjacent member.

The first shaft 42 may have a non-circular cross-section in the axial direction. The first shaft 42 may have a quadrangular cross-section in the axial direction. The first shaft 42 may rotate together with the handle 4. Even when the handle 4 and the first shaft 42 rotate, the first shaft mount 421 may not rotate. The first shaft mount 421 may be fastened to the case 31 and 32. The case 31 and 32 may be the case body 32. The first shaft mount 421 may include a housing 423 that supports the bearing. The first shaft mount 421 may include a wing 424 that extends further outward from the housing 423. The wing may be fastened to the case 31 and 32. Here, a screw may be used as the fastening member.

The opening module 30 in this embodiment may be manufactured in a compact size. Particularly, the thickness of the opening module 30 in the front-rear direction may be reduced. In addition, condensation may be prevented, and stable interaction between the members and a large initial force may be ensured. In addition, the present disclosure has the following operational features.

1. The handle 4 may push the link 7 in a pulling direction of the handle 4. The handle 4 may push the link 7 in a forward direction (−Y). The second pressing part 44 may push the third pressing part 72 forward. The thickness of the opening module 30 in the front-rear direction (Y) may be reduced by the force acting thereon.

2. The front surface (−Y surface) of the handle 4 may push the rear surface (+Y surface) of the link 7 in a forward direction (−Y). The front surface of the second pressing part 44 may push the rear surface of the third pressing part 72. The opening module 30 may be provided in a more compact size by a reaction force reacting to the force.

3. Slip lengths, which are sliding amounts of two members, may be defined based on a contact portion C between the handle 4 and the link 7. The slip length of the link 7 may be smaller than the thickness of the link 7. The thickness of the link 7 may refer to the thickness of a cross-section taken along a normal to the extension direction of the second shaft 71. The link 7 may have a length, and a direction orthogonal to the length may be defined as the thickness. The thickness of the link 7 may be the thickness of the link 7 on the XY plane. As the slip length decreases, damage to members caused by friction may be prevented, thereby ensuring reliable operation of connected members.

4. The contact portion C between the handle 4 and the link 7 may move beyond the second shaft 71 during operation of the handle 4. Before the operation of the handle 4 and the link 7, the contact portion may be located on the front side (+Y) of the second shaft 71. After the operation of the handle 4 and the link 7, the contact portion may be located on the rear side (−Y) of the second shaft 71. Here, the front side and the rear side may be set based on the XZ plane including the second shaft 71. Before and after the operation of the handle 4 or before and after the operation of the link 7, the position of the contact portion is changed, thereby resulting in a shorter slip length. Accordingly, it is possible to prevent damage to the members, and improve operational reliability between the members.

The slip length may occur in both the link 7 and the handle 4. That is, a slip length of the link 7 and a slip length of the handle 4 may occur. In this embodiment, the slip length of the link 7 may be longer than the slip length of the handle 4. This is because the position of the contact portion of the link 7 may move beyond the second shaft 71.

5. The thickness/length (thickness divided by length) of the link 7 may be greater on the fourth pressing part 72 side than the third pressing part 72 side. In other words, the fourth pressing part 72 may have a smaller aspect ratio than the third pressing part 72. Here, the thickness and length may be determined based on an imaginary rectangle that encloses both of the third pressing part 72 and the fourth pressing part 73. The thickness and length of the link 7 may refer to the thickness and length of the link 7 on the XY plane. In the above configuration, a large force amplifying effect due to lever action may be achieved, and may be stably performed.

6. Of the handle 4 and the link 7, a thickest portion may be formed at the handle 4. The handle 4 may transfer an external force to both left and right ends. The handle 4 may preferably have a thickness large enough to counteract the bending stress. To this end, a plurality of reinforcing ribs may be provided. Due to the reinforcing ribs, the thickness of the handle 4 in the front-rear direction (Y) may be greater than that of the link 7. Accordingly, it is possible to induce stable operation of the opening module 30, thereby minimizing an error in dimensions that may occur during operation.

7. A first imaginary axis in the front-rear direction (Y) based on the first shaft 42 and a second imaginary axis in the up-down direction (Z) based on the first shaft 42 are provided. In the first embodiment, the second shaft 71 may be closer to the second imaginary axis than the first imaginary axis. In the second embodiment, the second shaft 71 may pass through the second imaginary axis. In the second embodiment, the second shaft 71 may be parallel to the first imaginary axis. When the first shaft 42 and the second shaft 71 have a predetermined range, the second shaft 71 may overlap the first imaginary axis in the second embodiment. In this configuration, the opening module 30 may be provided in a compact size.

8. The handle 4 may rotate about the first shaft 42 in the first direction. The link 7 may rotate about the second shaft 71 in the second direction. In the first embodiment, the handle 4 and the link 7 may rotate in opposite directions. The handle 4 may rotate in a clockwise direction (+X) with respect to the left-right direction (X), and the link 7 may rotate in the clockwise direction (+X) with respect to the left-right direction (X). In the second embodiment, the handle 4 and the link 7 may rotate in opposite directions. In the second embodiment, the handle 4 and the link 7 may rotate in directions intersecting each other. In the second embodiment, the handle 4 may rotate in a clockwise direction (+X) with respect to the left-right direction (X), and the link 7 may rotate in the clockwise direction (+Z) with respect to the up-down direction (Z). By the rotation directions of the handle 4 and the link 7, the opening module 30 may be provided in a narrow space.

9. A first imaginary axis in the front-rear direction (Y) based on the first shaft 42 and a second imaginary axis in the up-down direction (Z) based on the first shaft 42 are provided. A quadrant may be provided using the first imaginary axis as the X-axis and the second imaginary axis as the Y-axis. For example, based on the first shaft 42, a YZ plane may be provided, and a quadrant may be provided. In this case, the contact portion C between the handle 4 and the link 7 may be placed on at least one of the first quadrant and/or the second quadrant. The contact portion may move on the first quadrant and the second quadrant. In this configuration, the opening module 30 which is narrow in the front-rear direction (Y) may be provided. The opening module 30 in this embodiment may be narrow in the front-rear direction (Y) and long in the up-down direction (Z). In this embodiment, the length of the opening module 30 in the up-down direction (Z) may be greater than the thickness of the opening module 30 in the front-rear direction (Y).

10. A contact portion C between the handle 4 and the link 7 is provided. In this case, a distance between the contact portion and the first shaft 42 may be greater than a distance between the contact portion and the second shaft 71. Here, the distance may be determined based on the YZ plane. In this manner, it is possible to induce amplification of force by the handle 4. Accordingly, the opening module 30 may be larger in the up-down direction than in the left-right direction, thereby allowing the opening module 30 to be provided in a compact size.

11. A contact portion C between the handle 4 and the link 7 is provided. In this case, the contact portion may move in a forward direction (−Y) during operation of the opening module 30. The opening module 30 may be provided in a narrow space by movement of the contact portion.

12. The link 7 may have a first region close to the second shaft 71, and a second region far from the second shaft 71. The first region may be thicker than the second region. In this configuration, it is possible to prevent members from being deformed when an external force is applied. Accordingly, force transmission may be achieved with accurate distance and direction.

13. A total length of the handle 4 may be longer than a total length of the link 7. Here, the lengths may be determined based on the YZ plane. As the handle 4 is longer, significant force amplification may be provided by the handle 4. By allowing the handle 4 to extend sufficiently in one direction, the opening module 30 may be reduced in size.

14. A point where an external force is applied to the first pressing part 43 is referred to as a point of action (see A in FIG. 5). A contact portion C between the handle 4 and the link 7 is provided. A distance between the point of action A and the contact portion C may be shorter than a distance between the point of action and the first shaft 42. Here, the length may be determined based on the YZ plane. In this configuration, an external force applied to the point of action may be amplified and applied to the link 7. Accordingly, the door may be initially opened with less force.

15. An imaginary line connecting the first shaft 42 and the second shaft 71 is provided. A first imaginary line may represent a shortest distance between the two shafts. For example, the imaginary line may be included in the YZ plane. An angle formed between the imaginary line and the front-rear direction (Y) may be greater than an angle formed between the imaginary line and the up-down direction (Z). The imaginary line may be close to a standing position. Here, the standing position may be determined based on the YZ plane. As described above, a center of motion of the handle 4 and the link 7 may be located in the up-down direction (Z). In this case, the opening module 30 may be narrow in the front-rear direction. Here, it should be noted that the front-rear direction is a thickness direction of the door. Accordingly, a thinner door may be provided.

16. A first imaginary line connecting the first shaft 42 and the second shaft 71 is provided. The first imaginary line may represent a shortest distance between the two shafts. For example, the imaginary line may be included in the YZ plane. A point where an external force is applied to the first pressing part 43 is referred to as a point of action A. A contact portion C between the handle 4 and the link 7 is provided. A second imaginary line connecting the point of action and the contact portion is provided. Both of the imaginary lines may be determined based on the YZ plane. A length of the first imaginary line may be longer than a length of the second imaginary line. In this configuration, each contact portion may be disposed in one direction. Accordingly, an opening module 30 which is long in the up-down direction may be provided.

17. The elastic member may contact one surface of the pusher 6 and one surface of the support plate. The elastic member may push the pusher 6 in the front direction (−Y), thereby guiding an accurate motion of the pusher 6. The elastic member 64 may be provided in a horizontal direction, thereby guiding an accurate motion of the pusher 6.

18. A center line of the elastic member 64 may be located above a center line of the gasket 113. A center of gravity of the elastic member 64 may be located above (+Z) a center of gravity of the gasket. In this configuration, the pusher 6 and the gasket may operate without interfering with each other. In this configuration, the opening module 30 may be provided in a compact size.

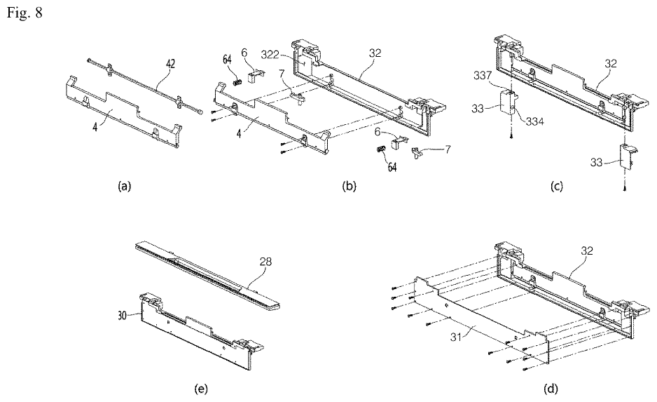

Referring to (a) of FIG. 8, the first shaft 42 may be seated in the handle 4. The seating of the first shaft 42 in the handle 4 may refer to (a) and (b) of FIG. 8.

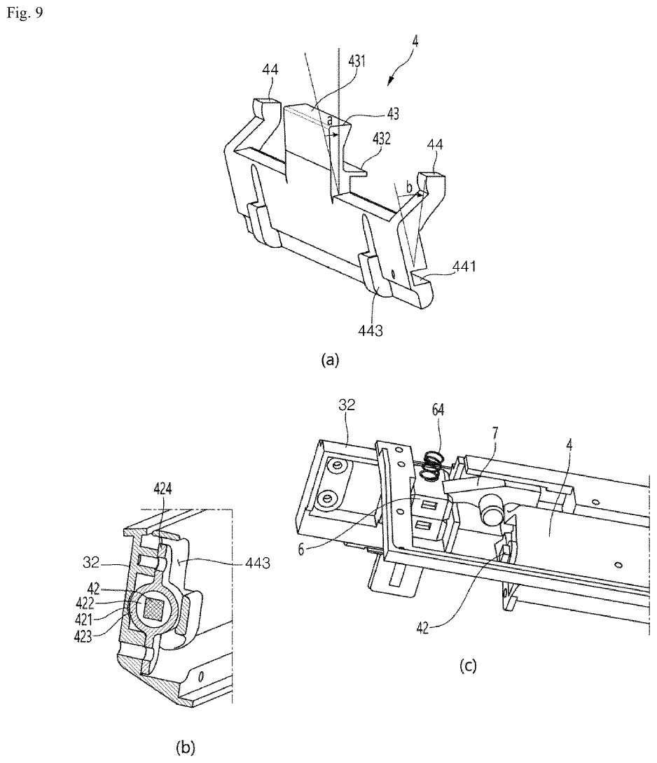

Referring to FIGS. 8(a), 8(b), and 9, a first shaft seating part 441, in which the first shaft 42 is seated, may be provided at a lower portion of the handle 4. At least a portion of the first shaft seating part 441 may have the same shape as the cross-section of the first shaft 42. The first shaft seating part 441 may have a quadrangular cross-section. The first shaft seating part 441 may be elongated in the left-right direction (X). A mount recess 443 may be provided at a position where the first shaft mount 421 is placed. The mount recess 443 may be recessed toward the front (−Y) of the handle 4. The mount recess 443 may accommodate at least a portion of the first shaft mount 421. The mount recess 443 may restrict movement of the first shaft mount 421. The first shaft 42 is seated in the first shaft seating part 441, and the first shaft mount 421 is seated in the mount recess 443, thereby completing the seating of the first shaft 42.

Referring to FIGS. 8(b) and 9, the case 32 and the handle 4 may be fastened to each other. The handle 4 may be fastened to the case 32 so as to be rotatable relative to the case 32. The first shaft mount 421 may be fastened to the case 32. A fastening member may be fastened in a rearward (+Y) direction. A wing 424 and the case 32 may be fastened to each other by the fastening member. The bearing may be disposed at a portion where the first shaft 42 and the case 32 are connected. The first shaft 42 and the handle 4 may rotate together. The case 32 may rotatably support the handle 4.

The pusher 6 may be mounted to the case 32. The pusher 6 may be temporarily assembled to the case 32. An elastic member 64 may be interposed between the pusher 6 and the case 32. The elastic member 64 may push the pusher 6 in a forward direction (−Y). The elastic member 64 may guide a default position of the pusher 6. The elastic member 64 may guide default positions of the handle 4 and the link 7. The default position may refer to a position of a corresponding part when no external force is applied thereto.

The link 7 may be mounted to the case 32. The link 7 may be temporarily assembled to the case 32. A bearing for the second shaft 71 of the link 7 may be mounted to the case 32.

The mounting of the pusher 6 and the link 7 may refer to (c) of FIG. 8. Referring to (c) of FIG. 8, the elastic member 64 may be provided on one surface of the pusher 6. An upper portion of the second shaft 71 of the link 7 may be supported by the case 32.

Referring to refer to (c) of FIG. 8, the supporter 33 may be fastened to the case 32. The second bearing 337 that supports the lower end of the second shaft 71 may be disposed on a first surface of the supporter 33. Here, the first surface of the supporter 33 may be an upper surface of the supporter 33. The first bearing 334 that supports the end portion of the first shaft 42 may be disposed on a second surface of the supporter 33. Here, the second surface may be a side surface of the supporter 33. Here, the side surface may be an inner surface facing the center of the handle 4. A third surface of the supporter 33 may guide movement of the pusher 6. The third surface may guide the lower surface of the pusher 6. A fourth surface of the supporter 33 may close the opening part 322 of the case 32. The fourth surface of the supporter 33 may include the second surface of the supporter 33. The fourth surface may include a front surface (−Y) of the supporter 33. An entirety of the wall surface of the case 32 may be closed by the supporter 33, thereby preventing a foam solution from entering the case 32.

Referring to (d) of FIG. 8, the case cover 31 may be fastened to the case 32. The case cover 31 and the case 32 may be fastened by a screw. A foam member may not be introduced from the outside into the interior space of the case 31 and 32.

Referring to (e) of FIG. 8, the opening module 3 may be fastened to the cap 28. Then, the cap 28 and the opening module 30 may be fastened to the door.

Referring to FIG. 9, the first pressing part 43 and the second pressing part 44 of the handle 4 may be bent in a forward direction (+Y) by a predetermined angle. A bending angle (a) of the first pressing part 43 may be smaller than a bending angle (b) of the second pressing part 44. In the above configuration, the opening module 30 may be provided in a narrow region in the front-rear direction (Y).

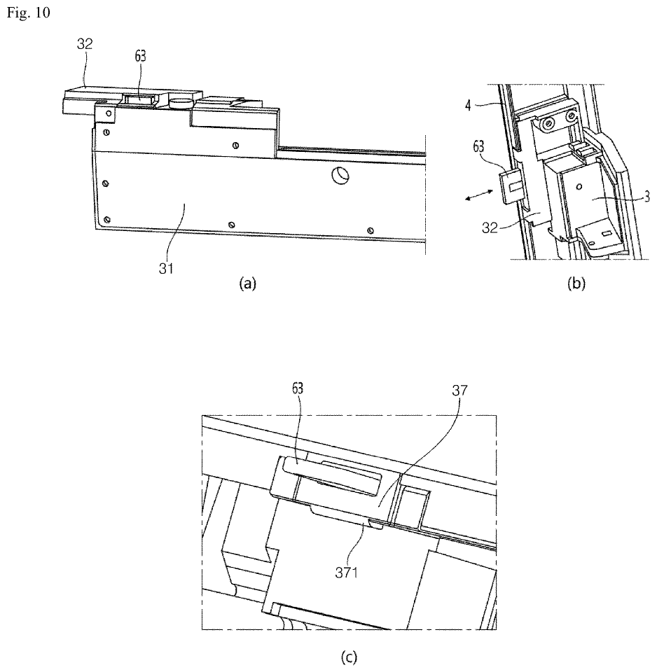

Referring to FIG. 10, the interior space of the opening module 30 may be shielded from the outside by the case 32, the case cover 31, and the supporter 33. The case 32 and the supporter 33 may guide movement of the pusher 6. The pusher 6 may be inserted and withdrawn forward and backward (Y). The pusher 6 may be inserted or withdrawn with a relatively long length. The cover 37, which guides insertion and withdrawal of an outer end 63 of the pusher 6 may protect the outer end of the pusher 6. The outer end 63 may be inserted and withdrawn through a narrow slit of the cover 37. The area of an inner surface of the slit may be almost equal to the cross-section of the outer end. The area of an inner surface of the slit may be slightly greater than the cross-section of the outer end. The cover 37 may be fixed as a fastening rib 371 is fastened to at least one of the case 32, the supporter 33, and/or the cap 28, or may be fastened by a fastening member using other methods. It is possible to prevent foreign materials from entering through the slit, thereby preventing product failure.

Hereinafter, a refrigerator according to another embodiment of the present disclosure will be described with reference to FIGS. 1, 2, and 11 to 18.

Except for some features of the opening module 30 and the door 20 the refrigerator 1, other features may be applied to the refrigerator according to this embodiment. The description of the first embodiment described above with reference to FIGS. 1 to 10 may be applied to this embodiment unless otherwise specified, and a redundant description of the same features as those in the above embodiment will be omitted.

For example, the structure of the handle 5 in this embodiment is different from the structure of the handle 4 in the above embodiment, and the structure of the handle 4 in the above embodiment may not be applied as it is to this embodiment, but its features may be applied. For example, the description of the cabinet 11 and the first door 12 and 13 in the above embodiment may be applied as it is to this embodiment.

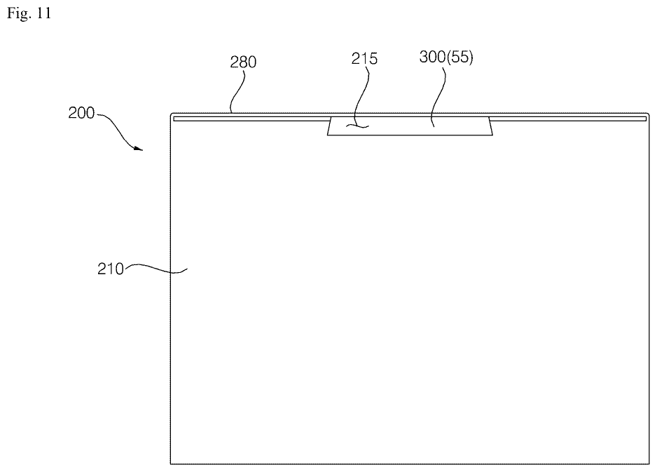

FIGS. 11 to 18 illustrate the door 200 and the opening module 300 according to another embodiment of the present disclosure.

Referring to FIG. 11, the door 200 may include a front panel 210. The front panel 210 may face forward. The front panel 210 may include an opening 215. The opening 215 may be formed at the center in the width direction (left-right direction) of the door 200. The opening 215 may be disposed adjacent to the upper end of the door 200.

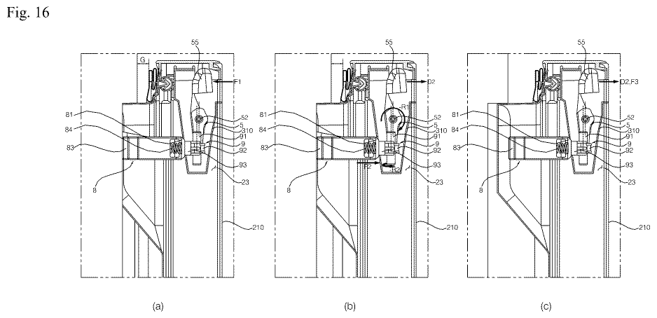

The opening module 300 may be exposed forward through the opening 215. A portion of the opening module 300 may be exposed forward through the opening 215. The opening module 300 may include an operation part 55 (see FIG. 16), and a front surface 551 of the operation part 55 may be exposed forward through the opening 215.

A user may operate the operation part 55 through the opening 215. The user may open the door 200 by operating the operation part 55. The user may initially open the door 200 by operating the operation part 55. The user may withdraw the door 200 forward by moving the operation part 55 in a first direction. For example, the user may withdraw the door 200 forward by pushing the operation part 55 rearward. The user may withdraw the door 200 forward by moving the operation part 55 upward.

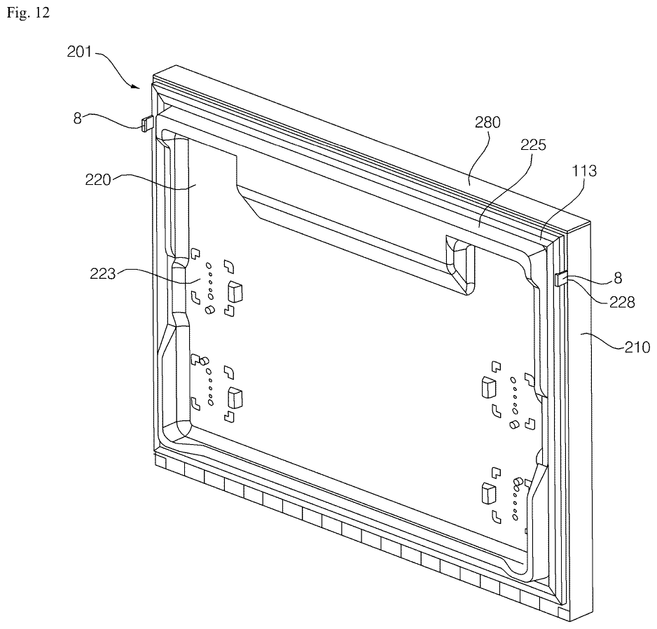

Referring to FIG. 12, the door 200 may include a door liner 220. The door liner 200 may face rearward. The door liner 220 may face the storage space.

The door liner 220 may be disposed behind the front panel 210.

The door liner 220 may include a rear rim 225 protruding rearward. The rear rim 225 may be inserted into a storage space 102 of the cabinet 11 when the door 200 is closed.

The rear rim 225 may extend along the perimeter of the storage space 102. The rear rim 225 may extend along the perimeter of the door liner 220. The opening module 300 may include a pusher 8 that pushes the cabinet 11 to open the door 200. The door 200 may have an opening 228 formed in a rear surface thereof, and the pusher 8 may move backward through the opening 228 formed in the rear surface of the door. The opening 228 may be formed in the door liner 220. Alternatively, the opening 228 may be formed behind the front panel 210. The opening, through which the pusher 8 passes, may be located below the opening 215 of the front panel 210.

The door 200 may include a gasket 113. The gasket 113 may be disposed on a rear surface of the door part 201. The gasket 113 may extend along the perimeter of the door. For example, the gasket 113 may be coupled to the door liner 220. The gasket may be disposed on the outside of the rear rim 225.

The gasket 113 may be disposed between the rear surface of the door part 201 and the cabinet 11. An upper portion of the gasket 113 may contact the partition part 115, and a side portion of the gasket 113 may contact a front end 112 of a side wall 111 of the cabinet 11. A lower portion of the gasket 113 may contact a front surface of the bottom of the cabinet 11.

The gasket 113 may seal a gap between the storage chamber 102 and the door 20 so as to prevent leakage of cold air of the storage chamber 102 when the door 20 is closed.

The pusher 8 may be disposed outside a region surrounded by the gasket 113. The pusher 83 may be disposed on the outside of the gasket 113 in the left-right direction.

Referring to FIGS. 11 and 12, the door 200 may include a cap 280. The cap 280 may define the upper surface of the door 200. The cap 280 may cover an upper portion between the front panel 210 and the door liner 220.

Unlike the cap 280 described above with reference to FIGS. 1 to 10, the cap 280 in this embodiment may not include a cap recess.

The opening module 300 may include a case 310 similarly to the embodiment described above with reference to FIGS. 1 to 10, and the case 310 may be mounted to the cap 280 (see FIG. 15).

Referring to FIGS. 1, 2, 11, and 12, the door 200 may include the door part 201 that closes the storage space 102 of the cabinet 11, and a basket 202 disposed behind the door part 201 and in the storage space. The door 200 may be withdrawn forward from the storage space 102.

The door liner 220 has a rail recess 223, and a rail 29 may be mounted to the door part by the rail mount 221 and the fastening member. Alternatively, the rail 29 may also be mounted to the basket 202.

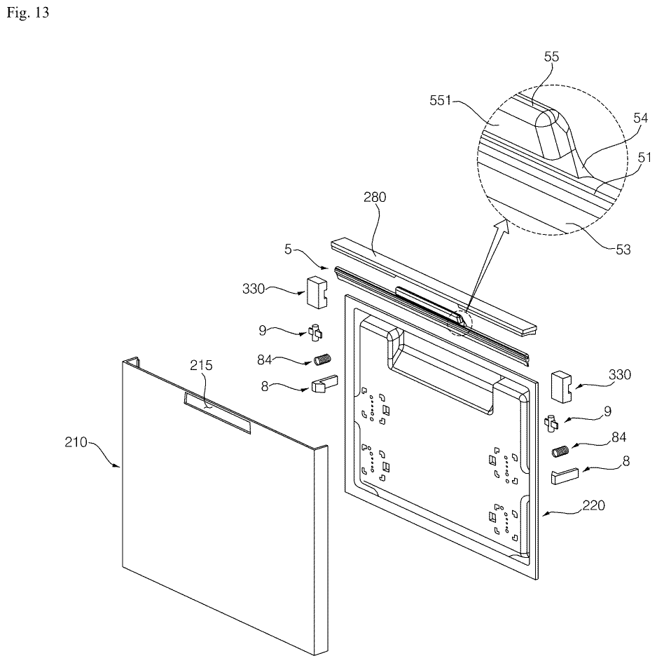

Referring to FIG. 13, the refrigerator may include the opening module 300. The opening module 300 may be disposed inside the door part 201. That is, the opening module 300 may be disposed between the front panel 210 and the door liner 220. The opening module 300 may be exposed forward through the opening 215. A portion of the opening module 300 may be exposed forward through the opening 215.

The opening module 300 may include the handle 5, the link 9, and the pusher 8. The opening module 300 may further include the elastic member 84.

The opening module 300 may further include a supporter 330 that rotatably supports the handle 5. The supporter 330 may be disposed at a side end of the handle 5. The supporter 330 may rotatably support the link 9.

The link 9 and the pusher 8 may include a first and second link 9 and a first and second pusher 8 that are disposed at both ends of the handle 5.

The handle 5 may include an operation part 55 that is exposed to the outside. The operation part 55 may be exposed forward through the opening 215. A front portion 551 of the operation part 55 may be exposed forward through the opening 215.

The handle 5 may include a body 51. The body 51 may extend in the left-right direction. The body 51 may extend in the width direction of the door 200. The body 52 may extend longer than the operation part 55 in the width direction of the door 200.

The handle 5 may include the operation part 55 and a neck 54. The neck 54 may extend from the body 51 and may be connected to the operation part 55. The neck 54 may be connected to a rear surface 552 of the operation part 55 which will be described later.

The neck 54 and the operation part 55 may extend upward from the center of the body 51.

The handle 5 may include a lever 53. The lever 53 may protrude downward from the body 51.

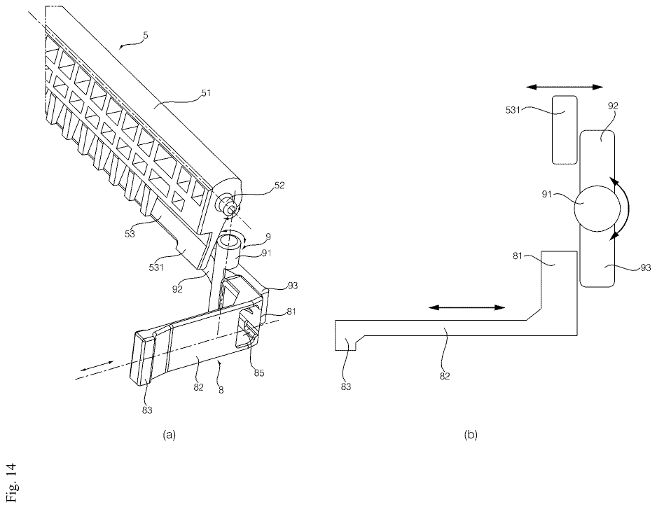

Referring to FIG. 14, the handle 5 may include a first shaft 52 defining the center of rotation of the handle 5. Hereinafter, the first shaft 52 will be referred to as a rotating shaft 52 of the handle 5 or a first rotating shaft 52. The rotating shaft 52 may protrude from the body 51 in the left-right direction.

Unlike the example, it is also possible that the body 52 has a groove, and a shaft protrudes from the case 310 or the door 200 to be inserted into the groove to define the rotating shaft 52 of the handle 5.

The components of the handle 5 may integrally rotate about the first rotating shaft 52. The operation part 55, the neck 54, the body 51, and the lever 53 may integrally rotate about the first rotating shaft 52.

The lever 53 may extend from the body 51. The lever 53 may extend downward from the body 51.

The lever 53 may include first and second side ends 531 protruding downward from the left and right side ends of the body 51. The lever 53 may extend between the first and second side ends 531 in the left-right direction. Alternatively, the lever 53 may protrude only from the side end of the body 51, unlike the example illustrated in FIG. 16.

An outer end of the operation part 55 may be located further outward than an outer end of the lever 53 in a radial direction.

The opening module 300 may include a link 9. The link 9 may connect the handle 5 and the pusher 8. The link 9 may contact the handle 5.

The link 9 may be disposed below the center of rotation 52 of the handle 5. A rotating shaft 91 of the link 9, which will be described below, may be located below the rotating shaft 52 of the handle 5.

The link 9 may be rotatable. The link 9 may include a second shaft 91. Hereinafter, the second shaft 91 will be referred to as a rotating shaft 91 of the link 9 or a second rotating shaft 91. The rotating shaft 91 of the link 9 may be disposed in a direction intersecting the center of rotation 52 of the handle 5. The rotating shaft 91 of the link 9 may be disposed in a direction perpendicular to the center of rotation 52 of the handle 5. For example, the rotating shaft 52 of the handle 5 may be disposed in the left-right direction, and the rotating shaft 91 of the link 9 may be disposed in the up-down direction.

The link 9 may include a first arm 92 and a second arm 93. The first arm 92 may extend from the rotating shaft toward the handle 5, and the second arm 93 may extend from the second rotating shaft 91 in a direction opposite the handle 5. That is, in the width direction of the door 200, the first arm 92 may extend inward from the second rotating shaft 91, and the second arm 93 may extend outward from the second rotating shaft 91.

The first arm 92 and the second arm 93 may integrally rotate about the second rotating shaft 91. The rotating shaft 91 of the link may also rotate integrally with the first arm 92 and the second arm 93.

The first arm 92 may be disposed at the front of the lever 53. The first arm 92 may be disposed at the front of a side end 531.

The first arm 92 may be connected to the lever 53. The first arm 92 may contact the lever 53. The first arm 92 may contact the side end 531 of the lever 52.

When the handle 5 rotates in a first direction so that the lever 52 moves forward, the link 9 may rotate so that the first arm 92 moves forward and the second arm 93 moves backward.

The second arm 93 may be connected to the pusher 8. The second arm 93 may contact the pusher 8. The second arm 93 may be disposed at the front of the pusher 8.

The second arm 93 may be longer than the first arm 92.

The pusher 8 may include an inner end 81 contacting the second arm 93, an extension portion 82 extending rearward from the inner end 81, and an outer end 83. The extension portion 82 may connect the inner end 81 and the outer end 83.

The outer end 83 may protrude to the outside of the door 200 as the pusher 8 moves. The outer end 83 may contact the front end 112 (see FIG. 1) of the side wall 111 of the cabinet 11.

The pusher 8 may have a vertical height that is greater than a width in the width direction of the door. The vertical height of the outer end 83 may be greater than the width in the width direction of the door. Vertical heights of the extension portion 82 and the inner end 81 may be greater than the width in the width direction of the door.

The pusher 8 may have an installation recess 85 in which the elastic member 84 is installed. One end of the elastic member 84 may be installed in the installation recess 85, and an opposite end thereof may contact the case 2 or the door 200.

When the handle 5 rotates in the first direction so that the lever 52 moves forward, the link 9 rotates in the second direction so that the first arm 92 moves forward and the second arm 93 moves backward, and the pusher 8 may move backward. In this manner, the outer end 83 may push the cabinet 11 to initially open the door 200.

The pusher 8 may be disposed below the operation part 55. The pusher 8 may be positioned at the same height as the link 9. The pusher 8 may be disposed adjacent to the side end of the door 200. The pusher 8 is disposed below the upper end of the door 200, so as to contact the side end 111 of the cabinet 11. The width of the pusher 8 in the left-right direction may be smaller than the height in the up-down direction.

The door 200 includes the basket 202, and food is stored in the basket, such that the basket is heavy, and its center of gravity is located below the handle part. The refrigerator according to this embodiment has an effect in that the point of action, at which the opening module 300 pushes the cabinet 11, is moved to a lower side below the operation part 55 to which a user applies force, such that rotation of the door may be prevented, and the force acting thereon may be transformed into a translation motion, thereby allowing the door to be opened easily with less force.

Referring to FIG. 15, the operation part 55 may include a front surface 551 and a rear surface 552. The operation part 55 may include a grip 550. The grip 550 may be disposed behind the front surface 551. The grip 550 may be disposed between the front surface 551 and the rear surface 552. The grip 550 may be recessed upward.

An insulation material may be filled in a space between the front panel 210 and the door liner 220. The insulation material may be filled in a space between at least a portion of the case 310 and the front panel 210.

As described above, a significant force may be required to initially open the door 200. A user may initially open the door 200 by operating the opening module 300.

Referring to FIG. 15 and FIG. 16(a), a user may open the door 200 by pushing the operation part 55 rearward.

When a force F1 is applied to the operation part 55 in a first direction D1 (rearward direction), the handle 5 may rotate about the rotating shaft 52 in the first rotation direction R1. In this case, the operation part 55 may move backward, and the lever 53 may move forward. It is illustrated in FIG. 15 that the first rotation direction R1 is a counterclockwise direction.

When the handle 5 rotates in the first rotation direction R1, the link 9 rotates about the rotating shaft 91, which intersects the rotating shaft 52 of the handle 5, in the second rotation direction R2. When the handle 5 rotates in the first rotation direction R1, the lever 53 pushes the first arm 92 forward such that the first arm 92 moves forward, and the link 9 rotates in the second rotation direction R2 so that the second arm 93 moves backward. When the link 9 rotates in the second rotation direction R2, the second arm 93 pushes the pusher 8 rearward.

When the link 9 pushes the pusher 8 rearward, the pusher 8 pushes the cabinet 11 rearward. For example, the outer end 83 of the pusher 8 may push the front end 112 of the side wall 111 rearward. As the cabinet 11 is fixed, the link 9, the handle 5, and the door 200 are pushed forward. That is, the pusher 8 slides rearward relative to the door 200, and may be fixed relative to the cabinet 11.

When the door 200 closes the storage space and no external force is applied to the handle 5, the pusher 8 may be in contact with the cabinet 11.

Alternatively, when the door 200 closes the storage space and no external force is applied to the handle 5, the pusher 8 is separated from the cabinet 11, and when the external force is applied to the operation part 55, the pusher 8 moves backward to contact the cabinet 11, and when the external force is applied to the operation part 55 in this state, the handle 5 further rotates such that the pusher 8 pushes the cabinet 11 and the door 200 may be withdrawn.

As illustrated in FIG. 15, when a user pushes the operation part 55 in the first direction D1 when the door 200 closes the storage chamber, the handle 5 rotates in the first rotation direction R1, the link 9 rotates in the second rotation direction R2, and the pusher 8 presses the cabinet in the first direction D1, thereby causing a gap G between the cabinet 11 and the door 200, and the door 200 is withdrawn in the second direction D2, to be in the state as illustrated in FIG. 16(a), such that the door 200 is initially opened.

A user may also open the door 200 by moving the operation part 55 upward. A lower end of the front surface 551 of the operation part 55 may be disposed in front of the center of rotation 51 of the handle 5. That is, when no external force is applied to the operation part 55, the handle 5 may rotate so that the lower end of the front surface 551 moves upward along an arc.

When the user moves the operation part 55 upward, the handle 5 rotates in the first rotation direction R1, the link 9 rotates in the second rotation direction R2, and the pusher 8 presses the cabinet 11 in the first direction D1, thereby causing a gap G between the cabinet 11 and the door 200, and the door 200 is withdrawn in the second direction D2 and is in the state illustrated in (a) of FIG. 16.

Referring to FIG. 16(b), the elastic member 84 may be compressed when the pusher 8 moves backward. In this case, the elastic member 84 may apply force F2 to the pusher 8 forward. When the external force applied to the operation part 55 is removed, the pusher 8 is moved forward by the elastic member 84, and the link 9 is rotated in an opposite direction (−R2) of the second rotation direction, and the handle may be rotated in an opposite direction (−R1) of the first rotation direction. Accordingly, the operation part 55 may move forward (D2). In this case, the opening module 300 may be in the state as illustrated in FIG. 15, and the door 200 may be in the state illustrated in (b) of FIG. 16 in which the door 200 is forwardly spaced apart from the cabinet 11.

Referring to FIG. 16(c), when an external force D3 is applied to the operation part 55 in the forward direction D2 when the door 200 is initially opened, the door 200 may be withdrawn forward to be opened further.

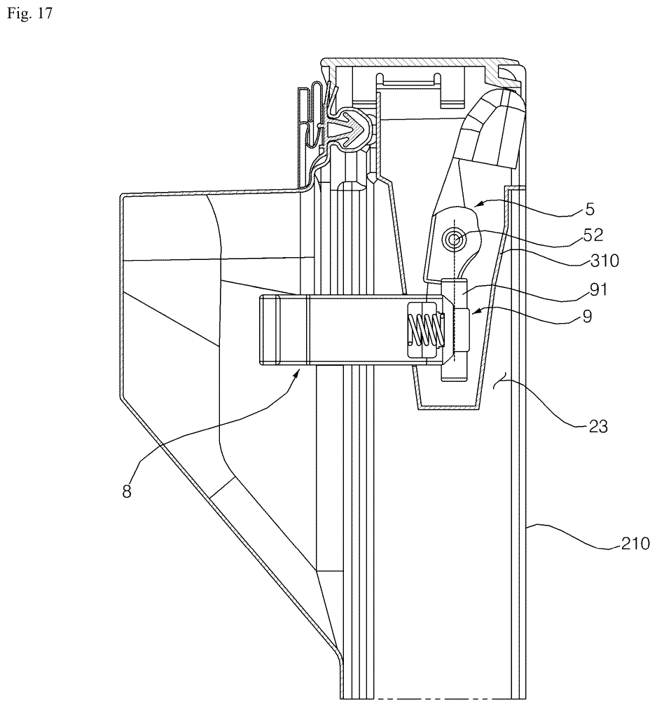

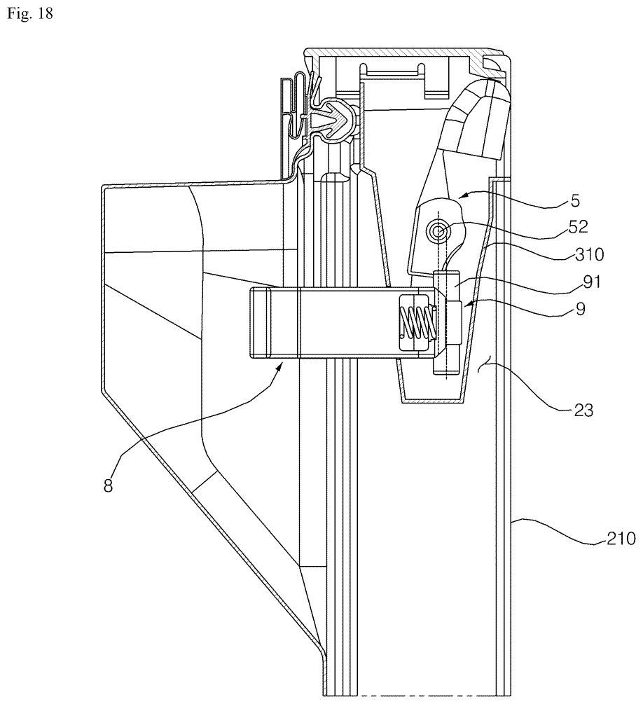

FIGS. 15 and 16 illustrate a refrigerator according to a second embodiment of the present disclosure, FIG. 17 illustrates a refrigerator according to a third embodiment of the present disclosure, and FIG. 18 illustrates a refrigerator according to a third embodiment of the present disclosure.

The respective embodiments illustrated in FIGS. 16 to 18 are different in terms of relative positions of the rotating shaft 52 of the handle 5 and the rotating shaft 91 of the link 9.

Referring to FIG. 16, the rotating shaft 52 of the handle 5 may be disposed in front of the rotating shaft 91 of the link 9 in the second embodiment.

The lever 53 may be disposed behind the first arm 92. The lever 53 may be disposed on an opposite side of the operation part 55 with respect to the rotating shaft 52 of the handle 5.

The lever 53 is disposed behind the first arm 92 and the rotating shaft 52 of the handle 5 is disposed in front of the rotating shaft 91 of the link 9, such that the operation part 55 of the handle 5 may be inclined forward when no external force is applied.

Accordingly, a user may easily push the operation part 55 rearward, and may rotate the handle 5 in the first rotation direction R1 by moving the operation part 55 upward to initially open the door 200.

Referring to FIG. 17, the rotating shaft 52 of the handle 5 may be disposed vertically above the rotating shaft 91 of the link 9 in the third embodiment. Even when the rotating shaft of the link 9 is located further outward than the rotating shaft of the handle 51 in the width direction of the door, the rotating shaft of the link 9 and the rotating shaft of the handle 51 may be disposed at the same position in the front-rear direction.

Accordingly, it is possible to reduce a space occupied by the opening module 300 in the front-rear direction.

In this manner, the door 200 may be designed to be thin.

Referring to FIG. 18, the rotating shaft 52 of the handle 5 may be disposed behind the rotating shaft 91 of the link 9 in the fourth embodiment.

The rotating shaft 52 of the handle 5 may protrude from the body 52, and the body 52 may be elongated in the width direction of the door. That is, by placing the rotating shaft 52 of the handle 5 behind the rotating shaft of the link 9, it is possible to secure a gap 23 between the case 310 and the front panel 210 of the door.

In this manner, when filling an insulation material in a gap between the front panel 210 and the door liner 220, the insulation material may be easily filled between the case 310 and the front panel 210.

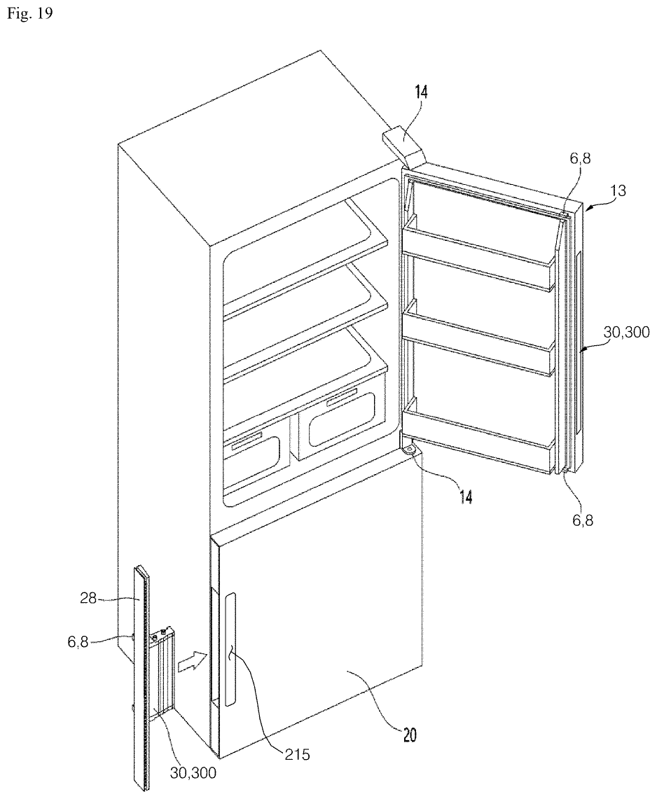

Hereinafter, a refrigerator according to a fifth embodiment of the present disclosure will be described with reference to FIG. 19. The refrigerator in this embodiment may include the opening module 30 and 300 described in the above embodiments.

The second door 20 may rotate about the hinge 14 to open or close the storage chamber. The opening module 30 and 300 may be mounted to the second door 20. The opening module 30 and 300 mounted to the second door 20 may be disposed on an opposite side of the hinge 14.

The opening module 30 and 300 may also be mounted to the first door 13.

The first door 13 may rotate about the hinge 14 to open and close the storage chamber. The opening module 30 and 300 mounted to the first door 13 may be disposed on an opposite side of the hinge 14.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator comprising:
a cabinet defining a storage space open toward a front;
a door disposed at a front of the cabinet and configured to open and close the storage space; and
an opening module disposed inside the door,
wherein the opening module comprises:
a handle including a handle rotating shaft defining a center of rotation in a left-right direction, an operation part exposed to an outside of the door and located above the center of rotation, and a lever located below the center of rotation;
a link including a link rotating shaft disposed in an up-down direction, a first arm extending from the link rotating shaft toward the handle and contacting the lever, and a second arm extending from the link rotating shaft toward an opposite side of the handle; and
a pusher configured to be pushed by the second arm to slide rearward and protrude from a rear surface of the door.

2. The refrigerator of claim 1, wherein when the handle rotates in a first rotation direction so that the operation part moves backward, the pusher moves backward.

3. The refrigerator of claim 1, wherein the cabinet comprises a side wall disposed outside the storage space in a width direction and extending vertically,
wherein the pusher is disposed in front of the side wall.

4. The refrigerator of claim 3, wherein when the handle rotates in the first rotation direction so that the operation part moves backward, the pusher moves backward relative to the door while being in contact with the side wall of the cabinet.

5. The refrigerator of claim 3, wherein a width of the pusher in the left-right direction is smaller than a height thereof in the up-down direction.

6. The refrigerator of claim 3, wherein the opening module further comprises a supporter disposed outside the handle in a width direction of the door and configured to accommodate the rotating shaft of the handle.

7. The refrigerator of claim 1, wherein the first arm of the link is disposed in front of the lever, and the pusher is disposed behind the second arm.

8. The refrigerator of claim 7, wherein a center of rotation of the handle is located in front of the rotating shaft of the link.

9. The refrigerator of claim 1, wherein the door comprises a front panel facing forward and having an opening,
wherein the operation part comprises:
a front surface facing forward and exposed to an outside through the opening of the door; and
a grip disposed behind the front surface and recessed upward.

10. The refrigerator of claim 9, wherein when the door closes the storage space, a lower end of the front surface of the operation part is disposed in front of the center of rotation of the handle.

11. The refrigerator of claim 10, wherein when the handle rotates in the first rotation direction so that the lower end of the front surface moves upward along a rotation trajectory, the pusher moves backward relative to the door.

12. The refrigerator of claim 9, wherein the handle further comprises:
a body defining the handle rotating shaft and extending in the left-right direction; and
a neck extending between the body and the operation part,
wherein the lever comprises a first side end and a second side end protruding downward from a left side end and a right side end of the body,
wherein the link comprises:
a first link contacting the first side end; and
a second link contacting the second side end,
wherein the pusher comprises:
a first pusher contacting the first link; and
a second pusher contacting the second link.

13. The refrigerator of claim 12, wherein the door further comprises a door liner facing the storage space and disposed behind the front panel,
wherein the opening module further comprises a case disposed between the front panel and the door liner of the door, and configured to accommodate the body, the lever, the link, and the pusher,
wherein an insulation material is filled in a gap between the front panel and the door liner of the door, and the insulation material is filled in a gap between at least a portion of the case and the front panel in a front-rear direction.

14. The refrigerator of claim 1, wherein the opening module further comprises an elastic member pressing the pusher forward.

15. The refrigerator of claim 1, wherein the door comprises:
a door part closing the storage space; and
a basket disposed behind the door part and disposed in the storage space,
wherein the door is withdrawn forward from the storage space to open the storage space, and is slid backward to close the storage space.

16. The refrigerator of claim 1, further comprising a hinge fixed to the cabinet,
wherein the door is rotatably coupled to the hinge to open and close the storage space, and the opening module is disposed on an opposite side of the hinge in the width direction of the door.

17. A refrigerator comprising:
a cabinet defining a storage space open forward;
a door disposed at a front of the cabinet and configured to open and close the storage space; and
an opening module disposed inside the door,
wherein the opening module comprises:
a handle including a handle rotating shaft defining a center of rotation in a left-right direction, an operation part exposed to an outside of the door and located above the center of rotation, and a lever located below the center of rotation;
a link including a link rotating shaft disposed in an up-down direction, a first arm extending from the link rotating shaft toward the handle and disposed in front of the lever, and a second arm extending from the link rotating shaft toward an opposite side of the handle; and
a pusher disposed behind the second arm, and configured to move backward and protrude from a rear surface of the door when the handle rotates in a first rotation direction so that the operation part moves backward.
